(19) United States
(12) Patent Application Publication
(10) Pub. No.: US 2006/0191577 A1
(43) Pub. Date: Aug. 31, 2006

(54) Hydro-controller

(76) Inventors: Richard Wills Schmidt, Bainbridge Island, WA (US); Mathew C. MacLearnsberry, Bainbridge Island, WA (US)

Correspondence Address: Mathew C. MacLearnsberry, 159 Wyatt Way N.E., Bainbridge Island, WA, 98110, US

(21) Appl. No.: 10/947,523

(22) Filed: Feb. 2, 2005

(51) Int. Cl. F17D 1/00

(52) U.S. Cl. 137/577

(57) ABSTRACT

The Hydro-Controller is a plumbing devise designed to control storm water runoff. It incorporates a new type of fitting, which we manufacture and call the S&M Adapter. This plumbing fitting allows us to revise the current art of storm water control by fastening a pipe-within-a-pipe, thus reversing the outflow direction by releasing the storm water from inside the riser (outlet chamber), rather than into the riser from outside via orifices and/or weirs mounted on the riser wall. This eliminates the need for a separate reservoir in the form of a catch basin or manhole within which to mount the flow control devise. The S&M Adapter provides other benefits, such as reducing the required size of the control structure, easy observation of the operation, ready access and easy removal of the flow-control pipe for cleaning and repair, or modification of the orifices for increased flow capacity, as well as greater economy in materials and installation, when compared with the current art.

### INTRODUCTION

The devise under consideration is a water flow regulator which is installed at the discharge side of any pond, vault or tank, that has been constructed to collect storm water runoff from a land development activity. Most jurisdictions in the United States now require that storm water discharge from any, heretofore, undisturbed property be limited to not more than the rate of runoff, which existed prior to the improvement of the property. Since rainfall will, naturally, flow off roofs, sidewalks and parking lots more rapidly than, say, forested land, some method must be devised to either retain this water on site, or detain it in some sort of reservoir so that it can be gradually released at a rate approaching pre-developed conditions. Where very permeable soil conditions are present on a development site a pond can be constructed, which contains enough surface area are to allow the water to be retained on-site and simply infiltrate back into the ground. This is, usually, not the case. Hence, the need for some sort of regulator to control the release rate of storm water from the site and adjust that rate to pre-developed site conditions. While there are standard components available in the marketplace from which to construct devices to control the discharge of storm water they result in bulky, relatively expensive structures made from a number of component parts, which require large equipment to assemble. Thus, there is a need for compact, self-contained, inexpensive and easy to install unit, which occupies little space and can be installed, if necessary, by hand labor.

A diagram of the standard storm water control structure used in most parts of this country is shown in Appendix A. Our invention, the Hydro-Controller, storm water discharge control structure replaces a portion of this system with a more simple and less costly devise. It is also more adaptable to different situations and requires less space to install.

### SPECIFICATION

I. Description and Application:

The Hydro-Controller is a compact, single-unit, plumbing devise, which is designed to be connected to the discharge side of a storm-water reservoir ( i.e. tank, pipe or pond) and control the release rate of water entering the reservoir by the use of an orifice, or a combination of orifices and weirs.

II. Operation:

As the water surface level rises in the adjacent reservoir water rises in the the inlet chamber of the Hydro-Controller, as well (see Appendix B, Sheet 3/6), and is released into the outlet chamber of the Hydro-Controller at an increasing rate of flow until a maximum flow rate is reached at the top of the inlet chamber's riser, the elevation of which coincides with the maximum desirable elevation in the reservoir. If the elevation of the water surface in the reservoir continues to rise above that of the riser in the Hydro-Controller the water spills over the top of the riser and into the Hydro-Controller's outlet chamber where it flows freely into the outlet chamber, or riser pipe, as this portion of the assembly would be called in the larger, conventional control structures.

III. System Components:

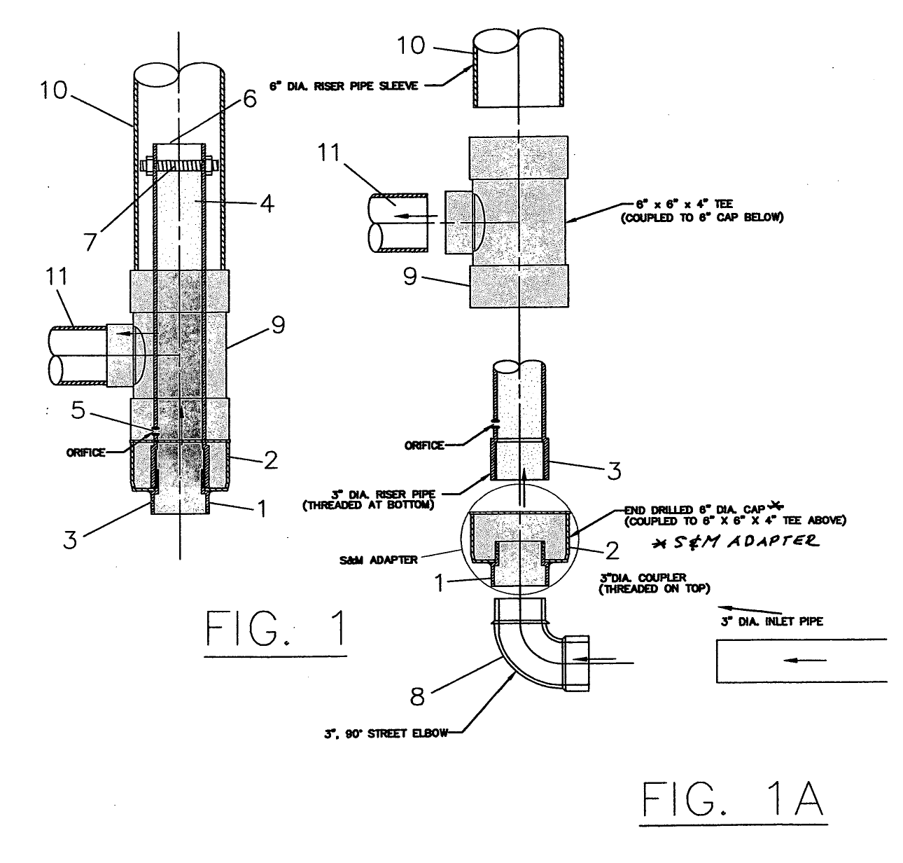

Illustrations of the Hydro-Controller are shown in Appendix B, Sheet 1/6. FIG. 1 shows the Hydro-Controller assembled. FIG. 1-A shows an exploded view of the Hydro-Controller. The Hydro-Controller is made up of two chambers, an inlet chamber and an outlet chamber.

The inlet chamber consists of the following components: A 3-inch diameter⁽¹⁾ threaded, male coupler (1), which is inserted into and bonded to an end drilled 6″ diameter cap (2) [the 6″ diameter cap also being the base of the outlet chamber]. A 3″ diameter, threaded, female coupler (3) is bonded to a 3″ diameter pipe (4) forming a removable flow-control pipe and completing the inlet chamber. The flow-control pipe contains one, or more, orifices (5) and, possibly, a weir at the top of the flow-control pipe, the combination of which control the discharge of water from the flow-control pipe into the outlet chamber as the water surface rises in the flow-control pipe. The top of the flow-control pipe is set at the same elevation as the adjacent water reservoir's maximum allowable water surface elevation and acts as an overflow (6). A ½ diameter, threaded rod (7) is bolted to the top of the riser pipe to facilitate removal of the flow-control pipe from its base for maintenance. The Hydro-Controller assembly receives water from the adjacent reservoir via a drain pipe, which is connected to a 3″⁽¹⁾ diameter, 90° elbow (8).
⁽¹⁾Piping and fitting sizes can vary, as required.

The outlet chamber consists of the following components: An end drilled 6″ diameter cap (2), a 6″×6″×4″ tee (9) and a 6″ diameter, riser pipe (10)⁽¹⁾, which surrounds the flow-control pipe. Water released into the outlet chamber flows into the outlet chamber's riser pipe(11), which discharges water to an adjacent water course.

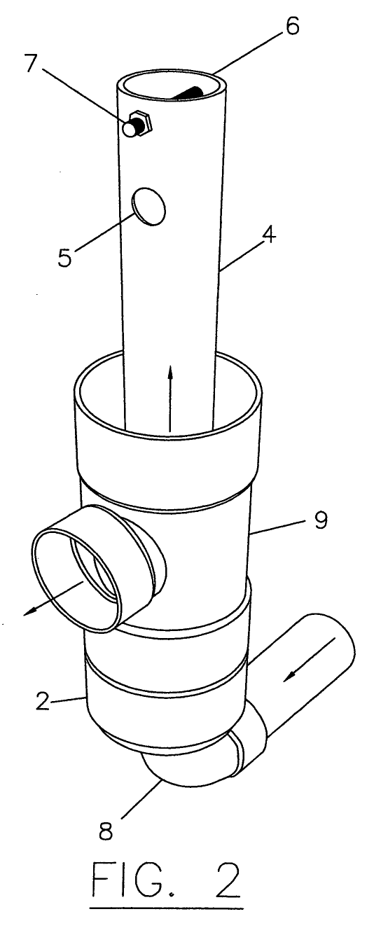

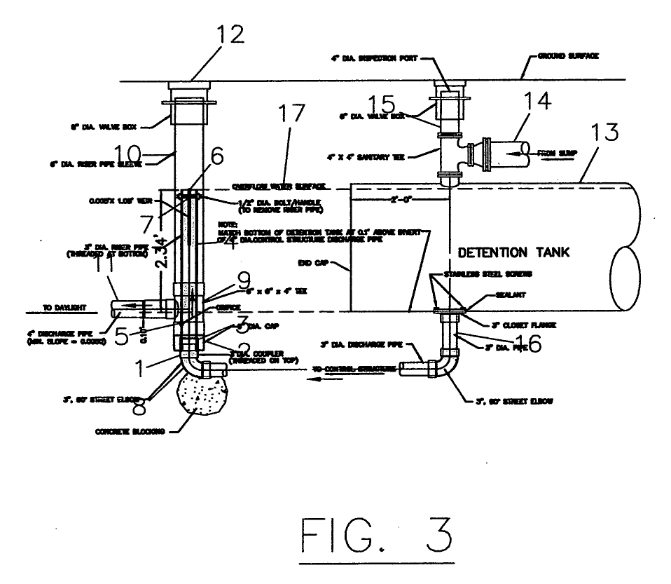

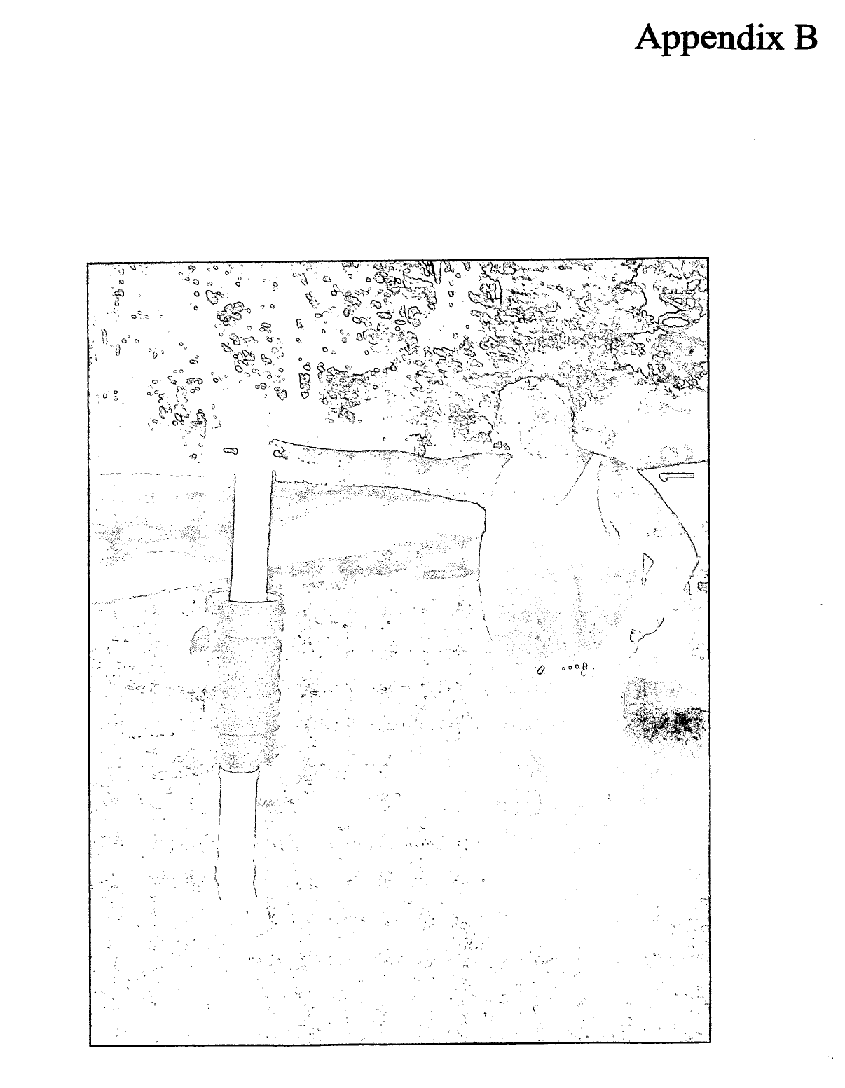

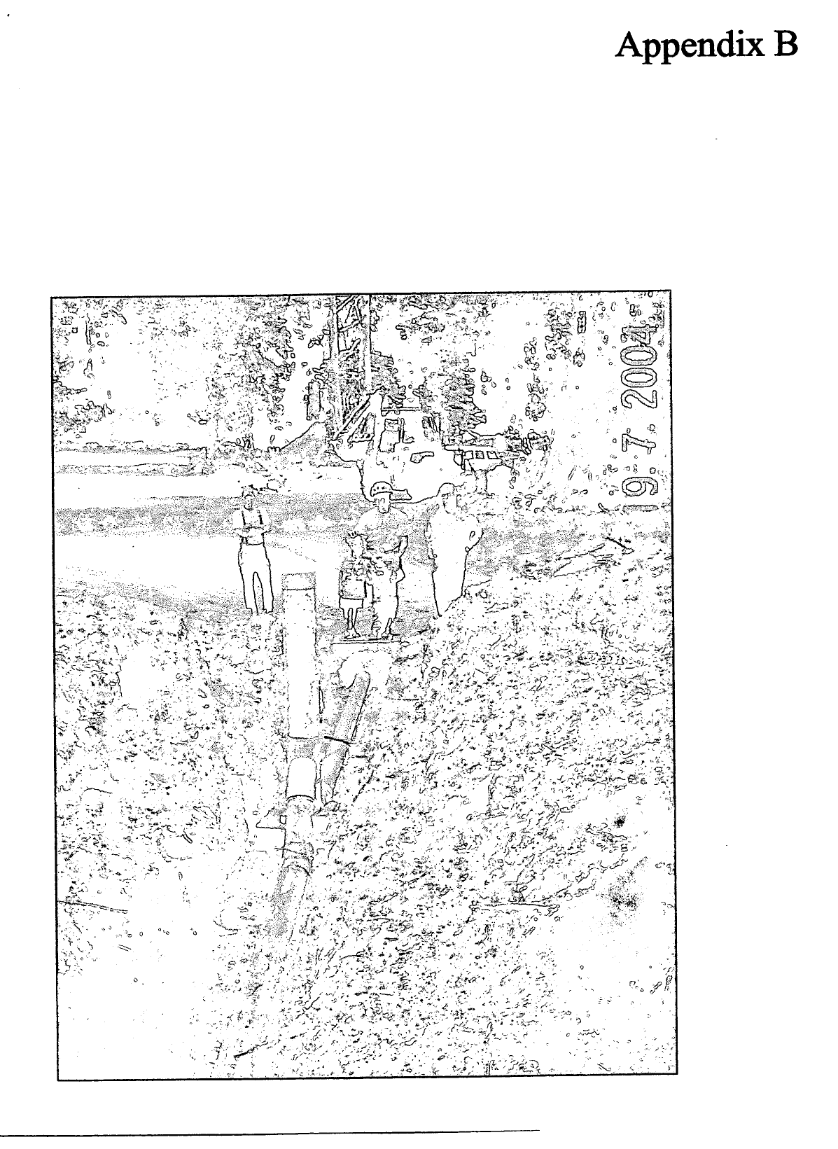

All of the above plumbing components, with one exceptions, are standard PVC and ABS, plastic pipe fittings. The threaded male coupler (1) bonded to the drilled cap (2), which form the bases of both the flow-control pipe and the outlet chamber, constitutes a unique type of pipe fitting in itself. This fitting, whether manufactured from individual fittings, or possibly molded as a single unit, is in itself a proprietary devise⁽²⁾. Exhibit B, Sheet 2/6, FIG. 2 shows a three-dimensional view of the Hydro-Controller, minus the riser pipe sleeve portion of the outlet chamber.
⁽²⁾Components (1) and (2) form the “S&M Coupler, which is not an off-the-shelf plumbing fitting, but must be manufactured.

IV. Relationship to Reservoir:

Appendix B, Sheet 3/6 shows a typical relationship between the Hydro-Controller and a typical water storage reservoir, in this case a pipe (13). A valve box (12) mounted at the surface of the ground provides access to the Hydro-Controller for inspection and for servicing of the riser pipe. The reservoir has a point of inflow (14), an inspection and service riser (15) and a discharge pipe (16), which flows to the Hydro-Controller. The top of the Hydro-Controller's riser pipe (6) is set at the level of the maximum allowable water surface in the reservoir (17). In this application the Hydro-Controller would be buried with the valve box cover (12) serving as an access and observation port.

V. Alternate Application:

The Hydro-Controller may also be used to control the discharge from a standard, Type I catch basin by simply mounting the Hydro-Controller within the catch basin and attaching it to the discharge pipe of the catch basin. In this application storm water runoff would be collected from a pipe entering the inlet side of the catch basin and being backed up through a third pipe into the detention facility, be it a pipe, pond or vault. Again, water would be released at a controlled rate, as the water surface rose in the detention facility (and, consequently, the catch basin and Hydro-Controller). In this application the 90° elbow (8) would be eliminated.

VI. Conclusion:

Since each situation in which the Hydro-controller is used will be unique the size of the pipes and fittings will vary, as well as the sizes and elevations of the orifices and/or weirs in the flow-control pipe, depending upon the quantity of water, or other fluid, being handled. These variables, of course, must be calculated by the Project Engineer, or Designer.

We claim:

1. Our invention the Hydro-Controller is a process of controlling the rate and volume of fluids flowing from a reservoir, tank or other holding facility by the steps of forcing the fluid to be discharged through a series of specifically sized, restrictive orifices and/or weirs in the vertical flow controller pipe thus achieving specific increasing rates of discharge as the fluid rises in the reservoir the fluid is then discharged through the outlet in the outer riser pipe.

2. A devise comprising an inner inlet chamber with a series of orifices and/or weirs to control flow attached to an outer collection and discharge chamber by means of the S&M Adapter.

3. The S&M Adapter is a new type of pipe fitting which we manufacture from a standard end cap which we machine to accept and bond to either a male or female adapter this fitting may also be molded in one piece.
